(19) United States
(12) Patent Application Publication
(10) Pub. No.: US 2018/0308024 A1
(43) Pub. Date: Oct. 25, 2018

(54) SYSTEMS AND METHODS FOR DATA-DRIVEN PROCESS VISUALIZATION

(71) Applicants: STEVE KILNER, Tempe, AZ (US); Sean Mann, St. Petersburg, FL (US)

(72) Inventors: STEVE KILNER, Tempe, AZ (US); Sean Mann, St. Petersburg, FL (US)

(21) Appl. No.: 15/962,714

(22) Filed: Apr. 25, 2018

Related U.S. Application Data
(60) Provisional application No. 62/489,456, filed on Apr. 25, 2017.

(51) Int. Cl. G06Q 10/06; G06T 19/00; G06F 17/30; H04N 21/472

(52) U.S. Cl. CPC G06Q 10/0633; G06T 19/006; G06F 17/30554; G06Q 10/067; H04N 21/47217; G06F 17/30607

(57) ABSTRACT

Apparatus and associated methods relate to constructing Virtual Reality models of business and organization operations. The models contain VR visual representations of a business's facilities, assets, processes, organization or other logical structures or useful management concepts. The model is then animated with visual representations of activities, workflow and other events that occur in the course of the business's operations as fed from the business's databases. The model can further be populated with camera feeds that are projected onto objects within the model, enabling real-world visibility within the animated model. The model can then be further populated with data feeds from Internet of Things sensor data providing detailed, streaming metrics associated with objects in the model. The model can depict activities, workflow, events, camera feeds and sensor feeds in real-time, as they occur, or it can depict historical views. The user is given extensive controls over navigating both the time and space of the VR model, all occurring in a 3D VR world, with six degrees of freedom in movement through the world, and elaborate options controlling the location, speed and direction of time. Users may also collaborate with each other by occupying the same VR model simultaneously and communicating with each other visually and through audio. All of this can be created by the user through simple configurations rather than through more costly programming work. Throughout, the term Virtual Reality also includes Augmented Reality and Mixed Reality.

### CROSS REFERENCE TO RELATED APPLICATIONS

This application claims the benefit of U.S. Provisional Application No. 62/489,456, titled “SYSTEMS AND METHODS FOR DATA-DRIVEN PROCESS VISUALIZATION,” inventors Steve Kilner and Sean Mann, filed by first-named inventor and applicant Steve Kilner, on 25 Apr. 2017.

This application incorporates the entire contents of the foregoing application herein by reference.

### TECHNICAL FIELD

Various embodiments relate generally to visualized scene execution of augmented and virtual reality models centered around organizational workflow and business management.

### BACKGROUND

Today's complex business processes are challenging to manage for efficiencies, optimization, and issue identification and resolution. Large organization may comprise hundreds of dispersed facilities, thousands of employees and partners and hundreds or thousands of systems. Understanding the state of the business and its ongoing operation is perhaps beyond the limits of human comprehension for managers who oversee such large operations, as well as for lower level employees who must collaborate with other employees or business partners who are geographically dispersed. How can someone “get their head around” organizations of such scale and complexity? A tool that could help them visualize operations anywhere in the world ˜real or systems—with the ability to navigate to any other place, or any other time of business events would be beneficial. Virtual Reality technology presents visualization opportunities an order of magnitude above those that are in common use today. The invention applies VR technology in novel ways to the management and collaborative problems faced by large organizations and makes the technology easy to implement without expensive programming work.

Visualizing business operation is distinct from visualizing business data. A useful analogy is to understand a business as a kind of machine. The machine has inputs, such as materials or labor, it has processes that transform or direct the input, and it has outputs, such as services or goods. There are things going in and things going out. Visualizing a business using a machine metaphor allows the business to be seen as it is operating. Yet, there has been no way to “see” a business running as a machine. Existing technologies fall short.

The technology that comes closest involves simulation tools. Simulation tools build models of such things as activities and events to find optimal designs. It is typically used where there is high incentive to get the design right before construction of, for example, hospitals, where there are no second chances. Such tools contain functionality for predictive analytics and algorithm development. Depending on the application, it can be useful to create a visualization of activities and events to show how the model will operate in actual use. It may also use historical data gathered from an enterprise database. But, that is usually a one-time data collection exercise, which is then used to feed the simulations.

Simulation tools are oriented to modeling rather than operations management. While simulation tools might be somewhat useful to visualize business operations, its purpose is different. The thrust of its functionality is different. It is meant to model a specific problem or process and create variation to work toward process model optimization. It is not intended to enable, and may not provide, the capability to visualize business operations as they are occurring, while also providing team collaboration capabilities.

Data visualization produces charts and graphs to distill and convey the essence of a lot of data. Occasionally there may be some movement in the graphs, but it is typically in the nature of growing and shrinking objects; for example, objects moving vertically or horizontally to represent changes in values, or objects blinking to bring attention to important data or changes in status or value.

Logistics routing visualization software such as some truck routing and scheduling optimization software, is directed to tracking vehicles on roads, for work such as shipping, maintenance and other tasks that are route-oriented. Vehicles use a device containing a GPS component so that it can transmit the vehicle location to a server where it can be visually displayed on a roadmap. Although it may be linked to tasks assigned to vehicles, logistics routing visualization is not particularly oriented to an organization's contextual workflow.

Machine operations analytics, such as some operational intelligence platforms, monitor data from system devices such as servers and routers. The purpose of analyzing machine operations is generally to monitor for problem events or capacity issues. While they report system workflow, machine operation analytic generally do not report business workflow. The functions provided are directed to monitoring and analytics—not visualization.

Process mining software may discover workflow patterns where they may not be known, and assists with identifying bottlenecks, redundant work, and non-compliant activities. While it uses workflow animation, process mining is not oriented to ongoing operations management. It is primarily a tool for analysts and consultants to discover and study an organization's workflow.

Business activity monitoring (“BAM”) tools generally provide analytics and dashboard for business operations and workflow. BAM emphasizes monitoring critical events, alerting to significant thresholds or conditions related to those events, and analyzing activity data analytics to find opportunities for operations optimization. BAM does not create animated workflows or attempt to visualize workflows beyond static diagrams.

What is needed therefore are systems and methods for data-driven process visualization and animation with integrated video and internet-of-things data all provided in a collaborative teamwork environment, and that these visualizations, animations and integrations be achievable primarily through simple configuration work rather than programming work, which is much more costly and time-consuming.

### SUMMARY

Apparatus and associated methods related to constructing Virtual Reality models of business and organization operations. The models contain VR visual representations of a business's facilities, assets, processes, organization or other logical structures or useful management concepts. The model is then animated with visual representations of activities, workflow and other events that occur in the course of the business's operations as fed from the business's databases. The model can further be populated with camera feeds that are projected onto objects within the model, enabling real-world visibility within the animated model. The model can then be further populated with data feeds from Internet of Things sensor data providing detailed, streaming metrics associated with objects in the model. The model can depict activities, workflow, events, camera feeds and sensor feeds in real-time, as they occur, or it can depict historical views. The user is given extensive controls over navigating both the time and space of the VR model, all occurring in a 3D VR world, with six degrees of freedom in movement through the world, and elaborate options controlling the location, speed and direction of time. Users may also collaborate with each other by occupying the same VR model simultaneously and communicating with each other visually and through audio. All of this can be created by the user through simple configurations rather than through more costly programming work. Throughout, the term Virtual Reality also includes Augmented Reality and Mixed Reality. Throughout, the tool allows the user to view and manipulate said model(s) in “real time,” in different visual formats, as the tool monitors, incorporates, illustrates and processes real world events for the user.

Various embodiments may achieve one or more advantages. For example, some embodiments may improve a user's ease of understanding the internal operation of a business. This facilitation may be a result of reducing the user's effort to visualize business organization events or activities. Various embodiments may reduce the cost to train new managers or consultants new to a business operation. Such reduced management training expense may be a result of creating animations of transactions and activities moving through the organization. In some embodiments, a user's visibility into business processes may be improved. Such improved business process visibility may be a result of real-time and historical VR visualization of the business process at work.

Some embodiments may improve business management productivity. This facilitation may be a result of providing multiple analysts with collaborative visualization of an executing VR business model. Various examples may increase a business process analyst's knowledge of real-time business process data. Such increased real-time business process data knowledge may be a result of constructing VR models of the business, then augmenting the VR models in an executable VR scene augmented with physical business parameters measured by IoT sensors, and automatically visualizing the models and business parameters while executing the VR scene.

### Definitions

Static objects: representational objects in scenes that do not move through space, e.g. a store, warehouse or a given activity represented at a fixed location in VR space in a workflow diagram. A Static object may be present or not depending on time, but they do not move through the VR space. Static objects also can have time-based “overrides” that change the object's size color, label, etc., as time progresses either forward or backward. The lists and properties of Static objects are retrieved from the user's database via configurations prepared by the user, requiring no programming other than substituting names in simple template SQL statements.

Dynamic objects: representational objects in scenes that can move through the visualized VR space over time e.g., a truck that moves from a warehouse to a store, or a purchase order that moves through a workflow process, from placement to fulfillment. Managing this movement via the product's extensive Clock manipulation features is a key part of the product. Lists and properties of Dynamic objects are retrieved from the user's database via configurations prepared by the user, requiring no programming other than substituting names in simple template SQL statements.

Transient objects: time-based, momentary representations of events pertaining to static objects. For example, a static object representing a store may briefly expand, shrink and change color to represent that a sale of an item has occurred. Data for transient objects are retrieved from the user's database via configurations prepared by the user, requiring no programming other than substituting names in simple template SQL statements.

Scene: a three-dimensional (3D), VR representation of the above-described objects and their movement and changes through space and time. Scenes may represent geography and physical objects, or may represent a virtual, logical space. In all cases, the locations and states of all objects are created and managed in all locations of a VRscene, whether currently visible to the user or not i.e., the state of the entire virtual world (scene) is continuously computed.

Clock: parameter that controls the time of a scene. The time starts where the first record from the customer's database starts and can be a) repositioned at will to any point in time within the confines of the user's data, and b) played back at any multiple of the real rate of time from infinitesimally slow or as fast as the user's computer can allow, or c) can go forward or d) backward or e) can loop between two points in time, reversing direction when either endpoint is reached, or f) loop and return directly to the start of the loop upon reaching the endpoint and g) may skip spans of no activity as requested. Also, if two or more instances of Vuzop are run simultaneously, the two clocks can be synchronized, optionally with an offset between them. So, for example, one scene may depict Monday at 8 am, and the other scene Tuesday at 8 am, for comparative purposes.

Instance: A given user-execution or session, of Vuzop. One user using Vuzop will normally be using one instance of Vuzop. Multiple instances are used for a) allowing multiple users to collaborate and view the same VR scene in synchrony, orb) one user viewing two or more views of the same scene where each view (instance) is synchronized with the master instance, typically with some offset from exact synchrony.

### BRIEF DESCRIPTION OF THE DRAWINGS

FIG. 1 depicts illustrative views of exemplary connection to business databases and feeds from facilities and IoT sensors, creation of visual elements for Static, Dynamic and Transient objects, control of the time-experience for the user in the scene, and realization of the overall scene in a VR space.

FIGS. 1A-1B depict illustrative views of exemplary connection to business databases and feeds from facilities and IoT sensors, creation of visual elements for Static, Dynamic and Transient objects, control of the time-experience for the user in the scene, and realization of the overall scene in a VR space.

FIGS. 2A-2B depict illustrative views of exemplary collaboration in a VR space.

FIG. 3 depicts an embodiment (VUZOP) exemplar animation of a national retailer's warehouses, stores and delivery routes

FIG. 4 depicts exemplary user navigation to focus attention on a Chicago warehouse.

FIG. 5 depicts exemplary user control facilities of the executing VR scene.

FIG. 6 depicts exemplary workflow animation of business processes.

FIG. 7 depicts exemplary collaboration with coworkers within a workflow animation VR scene.

FIG. 8 depicts exemplary Real-time workflow animation and data superimposed on live video feeds integrated with the executing VR scene.

FIG. 9 depicts illustrative components of an exemplary VUZOP system integrated with real-world physical facilities and IoT sensor data.

FIG. 10 depicts an exemplary VUZOP Framework.

FIG. 11 depicts exemplary organization of internal VUZOP system objects and properties.

FIG. 12 depicts exemplary further detail on organization of internal VUZOP system objects and properties.

FIG. 13 depicts exemplary components of the VUZOP user interface and presentation system.

FIG. 14 depicts an exemplary Sample Code Class Excerpt Illustrating High Level Scene Construction, disclosed as Appendix 1.

FIG. 15 depicts an exemplary Sample Code Class Excerpt IllustratingMoving the Virtual Camera within a Scene, disclosed as Appendix 2.

FIG. 16 depicts an exemplary Sample Code Class Excerpt Illustrating Initializing a Collaborator into the Active Scene, disclosed as Appendix 3.

FIGS. 17A-17B together depict an exemplary Sample Code Class Excerpt Illustrating user-configurable Scene Settings, disclosed as Appendix 4.

### DETAILED DESCRIPTION OF THE INVENTION

VUZOP Scene Creation and Display: As described above, VUZOP creates animation (“scenes”) of workflow activities and other business events by reading an organization's databases and integrating these scenes with video camera data and/or IOT data.

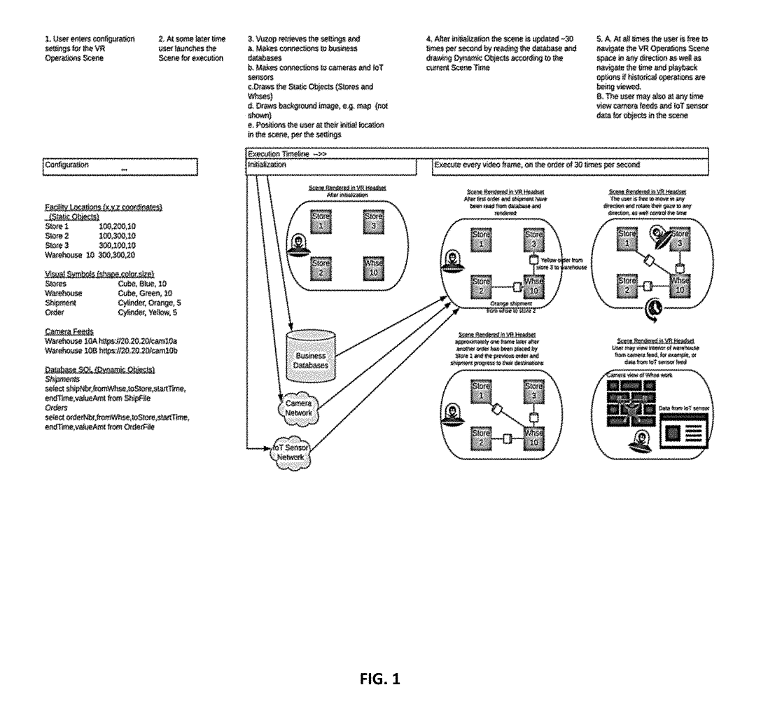

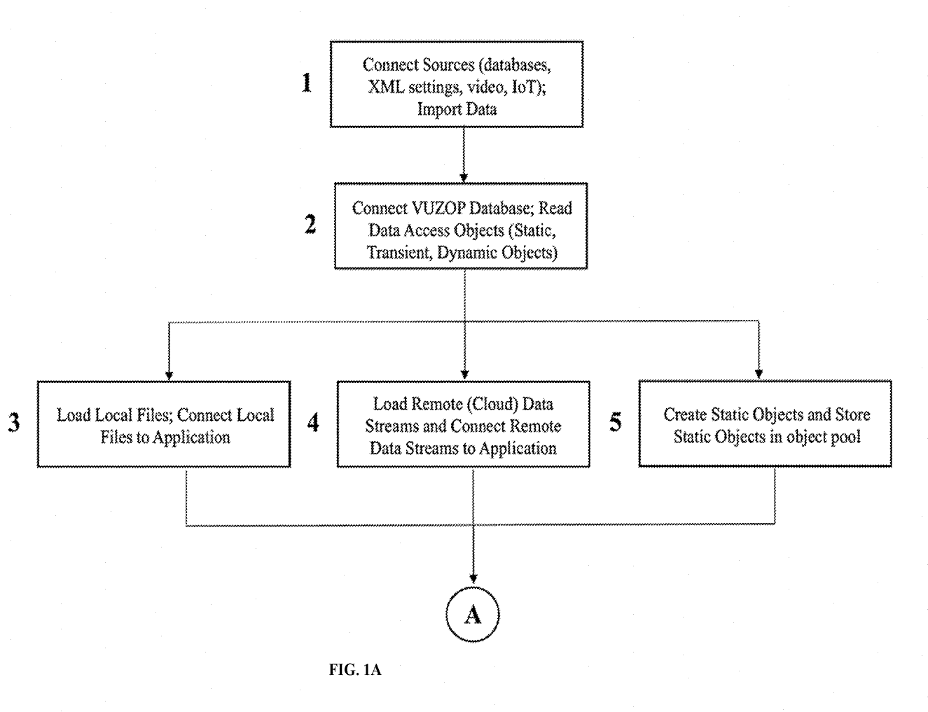

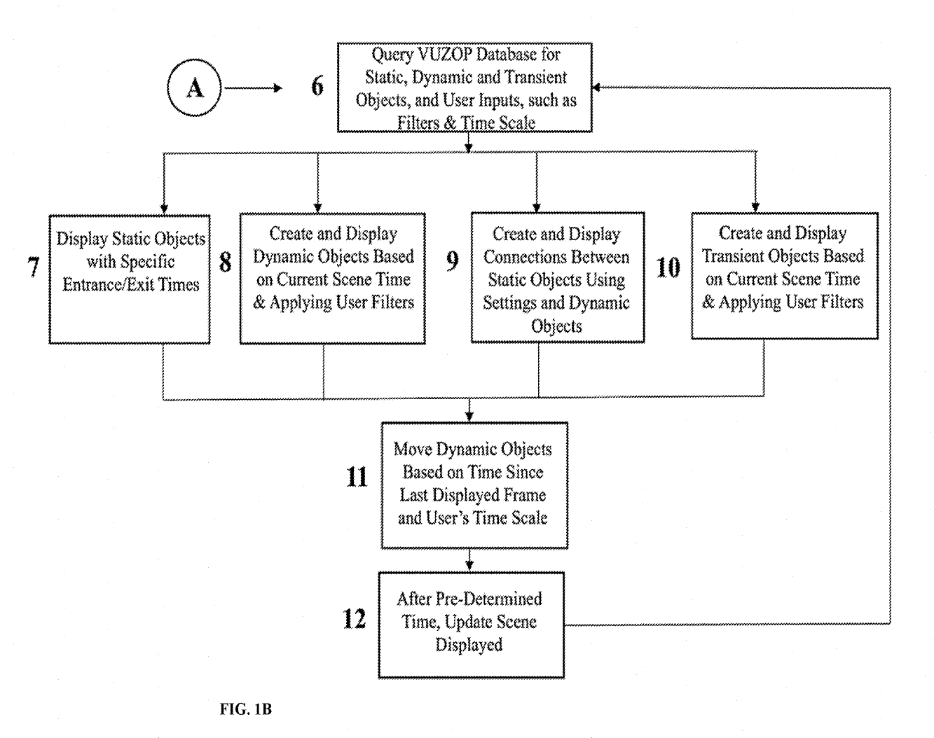

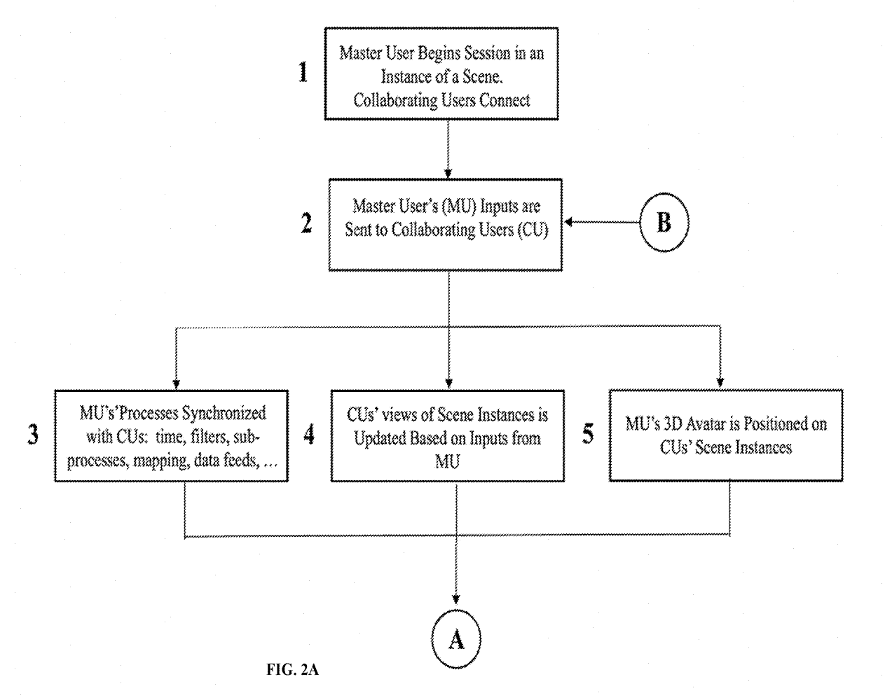

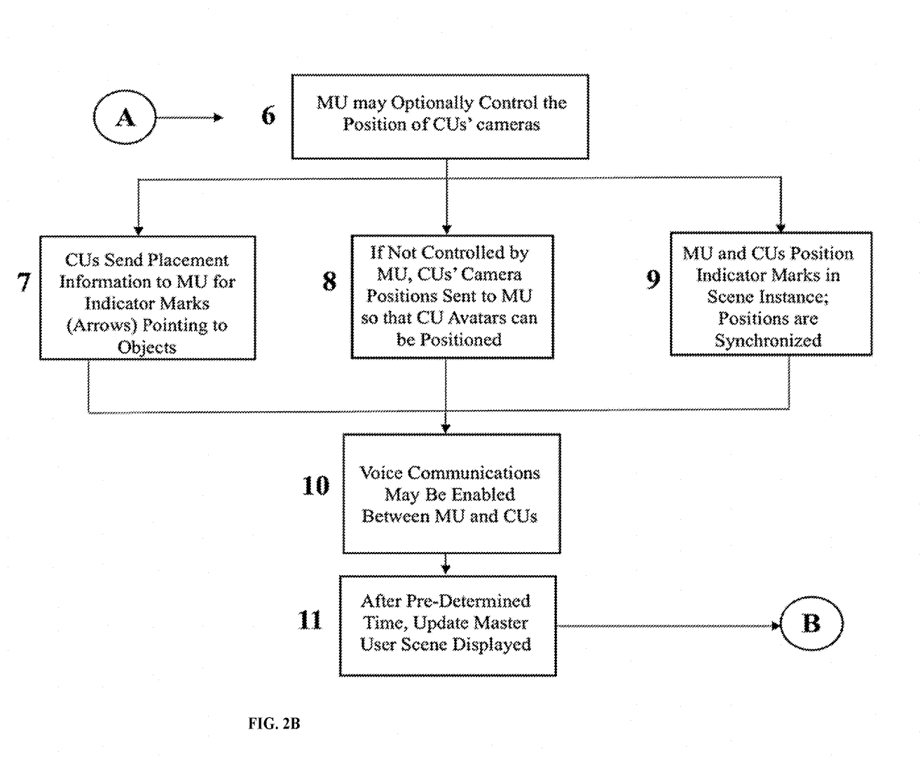

FIGS. 1 and 2 illustrate an exemplary process of the visualization system, constructing a VR model of business operations, animating the model with workflow, demonstrating business activities from the business database, and also integrating business camera feeds and IoT sensor data feeds.

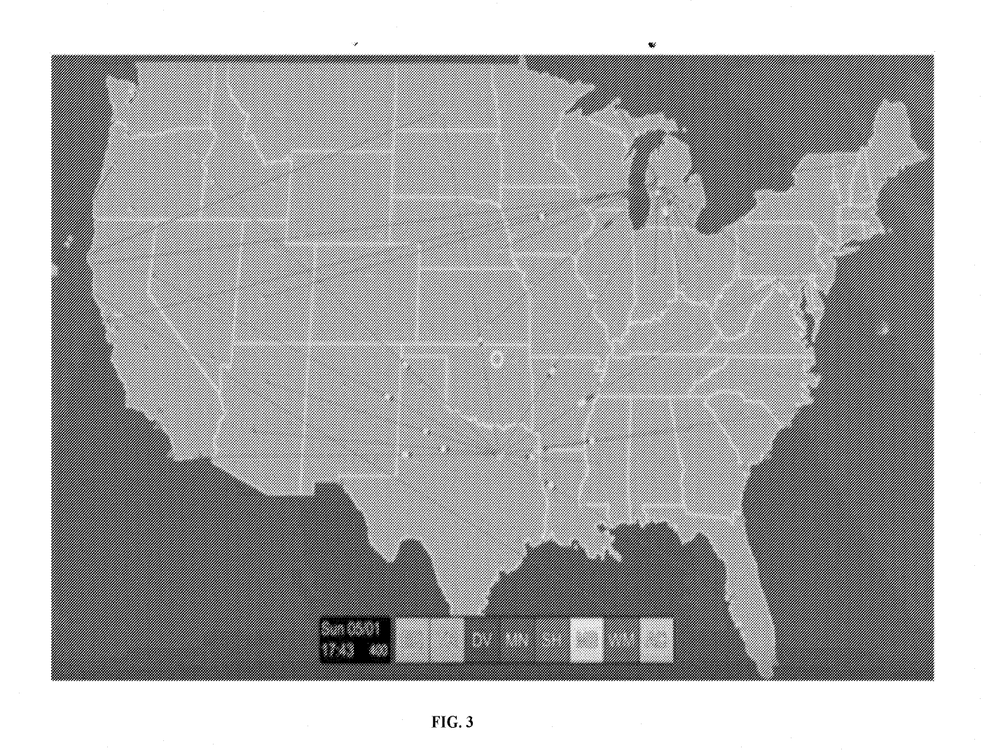

FIGS. 3-8 illustrate workflow activities by integrating an organization's data with video cameras and Internet of Thing (IoT) sensor data. Specifically, various embodiments of the invention facilitate user interaction with an organization's data in a two-dimensional (“2D’) or three-dimensional (“3D”) virtual reality (“VR”) space (“virtual space’).

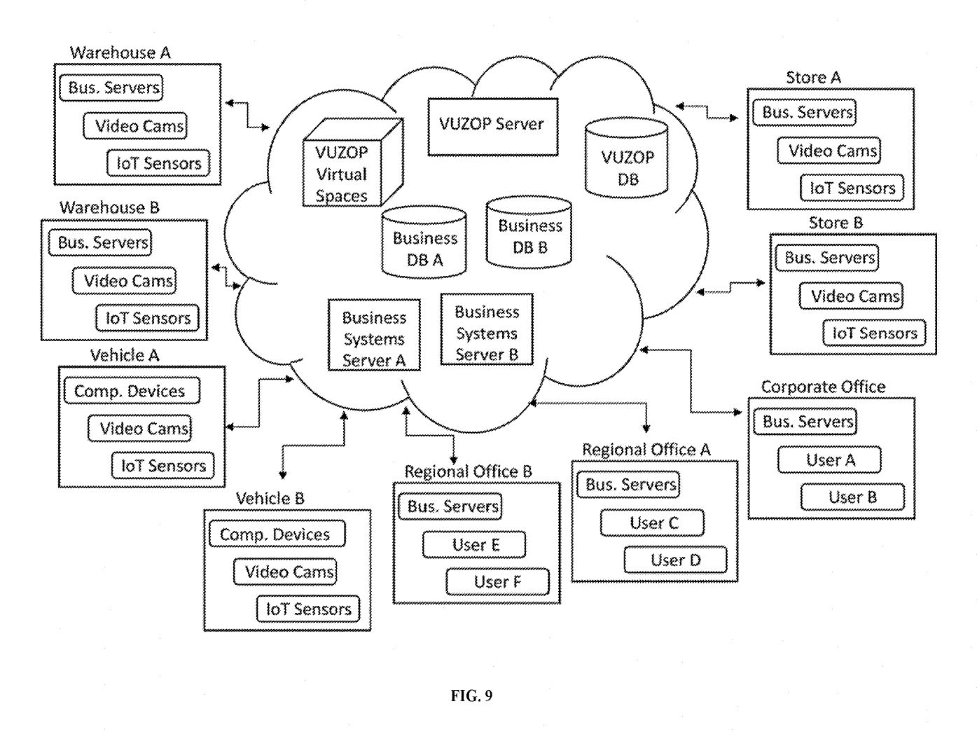

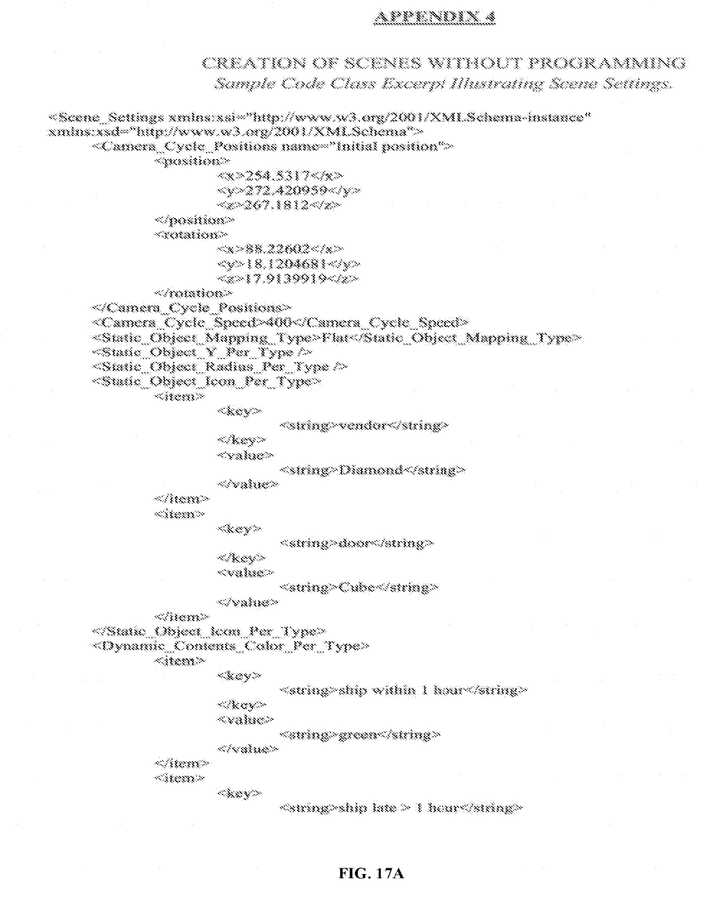

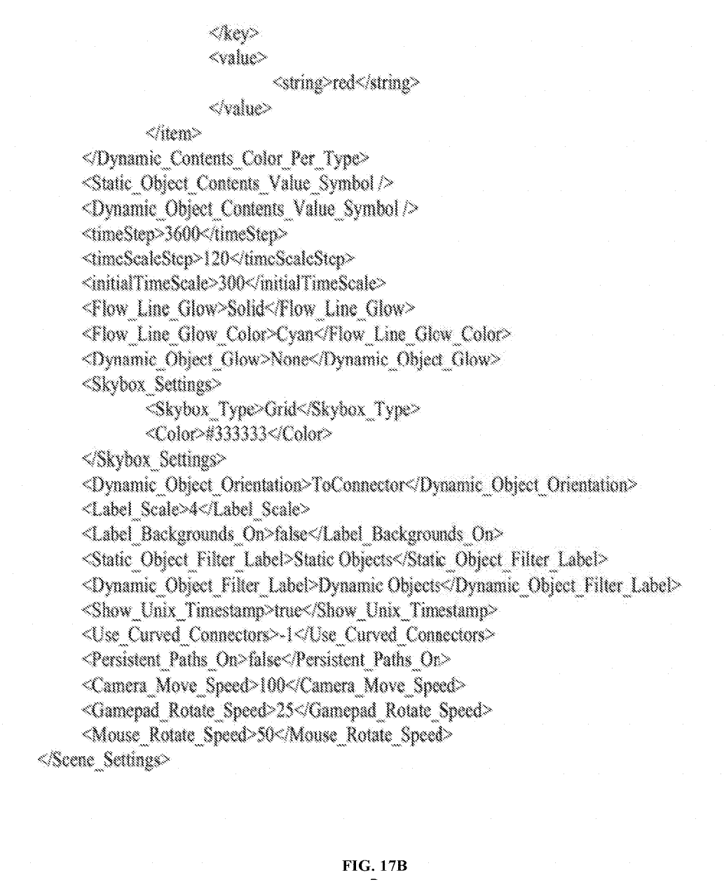

FIGS. 9-17B illustrate improvements in data-driven process visualization and animation with integrated video and internet-of-things data in a collaborative teamwork environment. FIGS. 9-17B illustrate (1) scene creation and display; (2) navigating user perspectives; and (3) enterprise work activity collaboration in a virtual space.

### DETAILED DESCRIPTION OF THE DRAWINGS

FIG. 1 is an overview of one embodiment of the Vuzop™ system/process/tool. A user enters configuration settings for a VR Operations Scene (“Scene,”), launches Scene execution, connects the system to devices (e.g. cameras, IoT sensors), draws static objects, background, positions user avatars and their viewpoints, initializes Scene at eg 30x/second, navigates the resulting/ongoing/updating VR Operations Scene w/optional playbacks, and User so navigates with option to view/add camera feeds and IoT sensor data for objects in the Scene. Sample Configurations are shown, e.g. shapes-representing-business facilities/activities/orders, objects and colors for exemplary stores, warehouses, camera feeds, databases for shipments with time values, and an exemplary business Scene layout using various IoT devices (for discussion only, as upcoming figures infra better exemplify the Vuzop system experience).

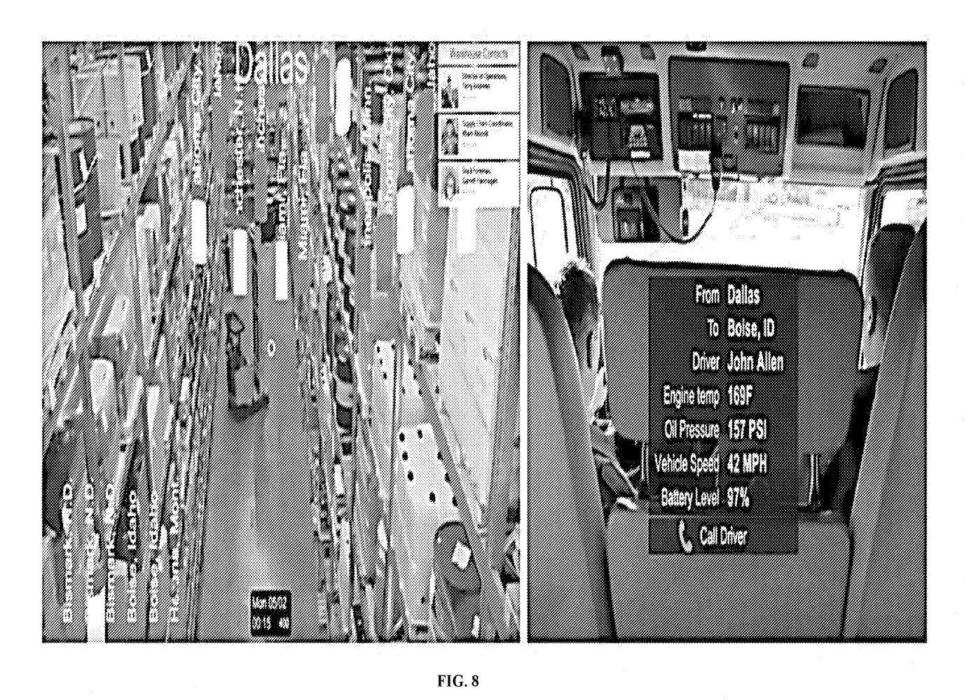

The “lower-right-corner” of FIG. 1 illustrates one visualization [for schematic explication only], a real-time user view of a particular camera feed of user's business warehouse ongoing work (“the weightlifter”=the worker in the warehouse whose work efficiency (e.g.) is viewable due to ‘data from IoT sensor’ at this buz. location). This visualization is made possible due to user's configuration of the System as shown [note: realistic exemplary “preferred embodiment” Vuzop™ system user views are more clearly shown infra, e.g. FIG. 8, infra], and their Navigation of the System as shown by the arrows (the user=the “little spaceman,” whose navigation into-and-out of various stores and warehouses, and what he sees as a result of navigating through these portals-via-objects, is exemplified in FIG. 1's exemplary schematic).

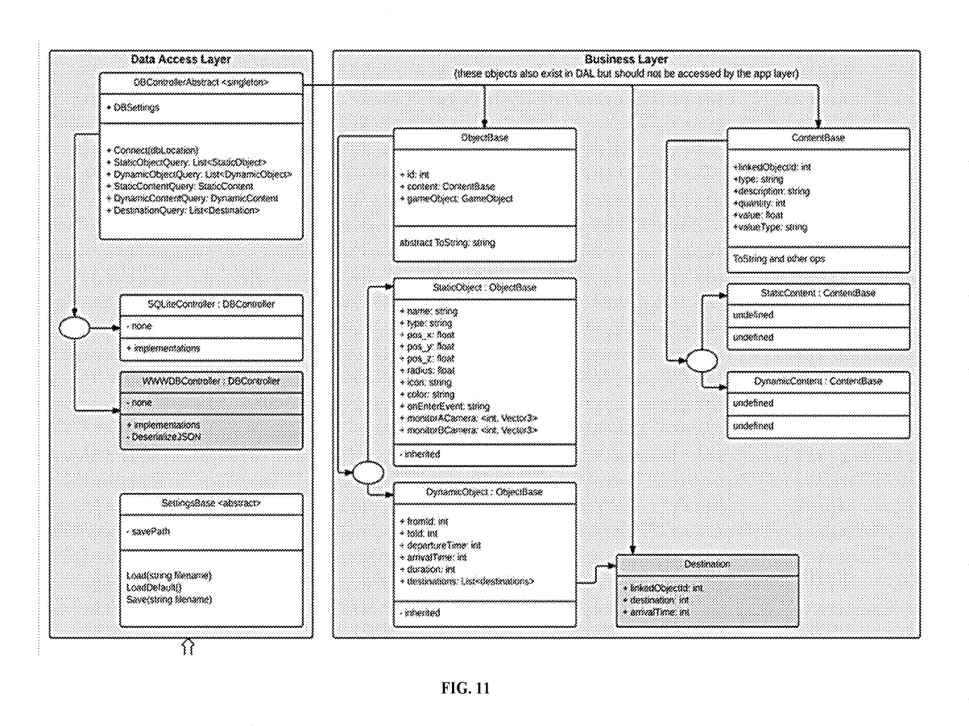

FIGS. 1A and 1B illustrate the steps (1-12) summarized below to implement the creation and display of scenes. In each step, related code classes (FIGS. 11-13) are referenced:
1. Connect Source; Import Data: Make connection to Database, XML settings file, local/remote video files, and Internet of Things' data feeds.
   a. Initializer.cs: Loads files, makes remote connections, sets up all components involved in the application.
   b. SettingsBase.cs: Base class for XML settings file.
   c. DBSettings.cs: Loads/saves XML setting file for db settings (connection string queries, filter, etc.).
   d. SceneSettings.cs: Loads/saves XML setting files for scene rendering options (time steps, object colors, mapping type, etc.).
2. Connect Database; Read Object:Connect to database and read Data Access Objects for Static Objects, Dynamic Objects, and Transient Objects.
   a. DAOController.cs: Base class for connecting to a database and retrieving Data Access Objects (DAOs).
   b. SQLiteControllerDAO.cs: Classes for making connection to database sources.
3. Load, and Connect to Application, Local Files: Load local files and connect them to parts of the application where they will be used/displayed.
   a. Initializer.cs: See above.
4. Load, and Connect to Application, Data Streams: Load remote video and Internet of Things (IOT) data streams and connect them to parts of the application where they will be used/displayed.
   a. Initializer.cs: See above.
   b. WWWFileLoader.cs
5. Create Static Objects and Store in Object Pool: Create static objects based on settings from Step 1 and data from Step 2.
   a. Initializer.cs: See above.
   b. StaticObject Factory.cs: Responsible for creating virtual representations of static objects based on queried data and scene setting. All static objects are created at this point and kept in an object pool.
6. Query Database for Dynamic and Transient Objects: Read database for dynamic and transient objects from Step 2. Batch data for these based on time.
   a. SceneController.cs: Controls when dynamic and transient objects are displayed based on queried results.
   b. DynamicObjectFactory.cs: Reads needed dynamic objects from database.
7. Display Static Objects with Specific Entrance/Exit Time: Read array of static objects created in Step 5. Set static object visibility based on any existing entrance/exit time in their data structure.
   a. SceneController.cs: Responsible for maintaining time and setting static object visibility.
   b. StaticObjectFactory: Responsible for maintaining a list of the static object datastructure and their states.
8. Create and Display Dynamic Objects: Create and display dynamic objects based on current time of the scene and apply any user filters.
   a. SceneController.cs: Responsible for maintaining time and setting dynamic object visibility (based on time and any user selected filters).
   b. DynamicObjectFactory.cs: Responsible for maintaining a list of the dynamic object data structures and their states and creating them a needed. This works off an object pooling pattern.
9. Create and Display Connections: Create and display connections between static objects based on settings and appearance of dynamic objects.
   a. SceneController.cs: Select connector from TransportLaneFactory to display or hide based on what dynamic objects will be shown from step 8.
   b. TransportLaneFactory.cs: An object pool pattern.
10. Create and display Transient Objects: Create and display transient objects based on the current time of the scene and any applied filters.
   a. SceneController.cs: Selects static objects that have transient objects associated with them. If it is the time to display the transient object then the command to invoke these is called.
   b. BlipController.cs: Displays visual changes for transient objects.
11. Move Dynamic Objects: Every displayed dynamic object is moved toward or away from its destination based on (i) the time since the last displayed frame and (ii) the user-controlled scale and direction of time.
   a. SceneController.cs: Responsible for calculating the distance to move each currently displayed dynamic object.
   b. DynamicObjectFactory.cs: Generate virtual representation of dynamic object that will move between static object.
   c. DynamicObjectMB.c: Registers user clicks to route to input controller and endpoints. Deal with Unity-specific behavior of Dynamic Objects.
12. User input: User input is collected to update any change in (i) current time selection (ii) filters, (iii) scene display, (iv) sub-processes currently being viewed (v) info tables displayed for dynamic/static objects and (vi) viewing of static object interiors.
   a. See Navigation User Perspectives below.

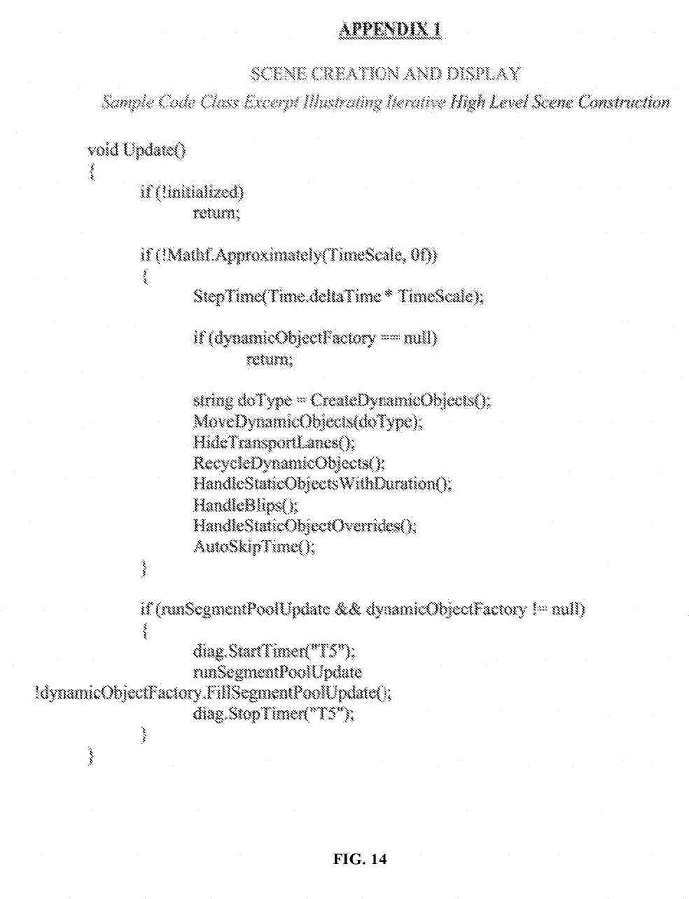

FIG. 14/Appendix I provides a sample code class excerpt which illustrates iterative high-level scene construction The Update function is called by Unity once per frame, or approximately 30-50 times per second, depending on the processing speed of the computer being used.

Navigating User Perspectives: VUZOP user creates, modifies and navigates the scene-using the parameter and filter described above, through a computer and virtual reality apparatus. The following table summarizes user input and references related code classes (FIGS. 11-13) as appropriate.

| USER | | |
|---|---|---|
| INPUT | DESCRIPTION | CODE CLASSES |
| User | Input received from a | InputSettings.cs. DAO |
| Input | mouse and keyboard or | Object for serializing XML |
| | XBox controller | input settings. |
| | | Initializer.cs: loads key |
| | | mappings from input settings |
| | | XML or defaults, connects |
| | | events of Input Controller to |
| | | various classes in the |
| | | application. |
| Move | Camera moves freely | InputController.cs: Listen |
| Camera | through the scene in 3- | for input from user, sends |
| | dimensions while also | events to camera |
| | freely rotating in 3 | controller. |
| | dimensions - so called | CameraController.cs: |
| | six degrees of freedom | Control movement of the |
| | | camera. |
| Time | User freely move through | InputController.cs: Listens |
| Controls | time: decreasing or | for inputs from user, sends |
| | increasing the playback | events to scene controller |
| | speed, reversing the | to alter time. |
| | time direction of | Initializer.cs: See above |
| | playback, shifting time | SceneController.cs: |
| | from one point to | Decides what data to show |
| | another, pausing time, | and how often to query |
| | setting loop to repeat | sources. |
| | a section of time. | |
| Filter | User selects various | Initializer.c: See above. |
| Controls | filters that will hide/ | InputController.cs: Listens |
| | display data based on | for inputs from user, sends |
| | the filters that have | information from UI filter |
| | been defined by the user, | panels to scene controller |
| | Dynamic Object types, or | UserDefinedFilterController.cs: |
| | Static Object IDs. | Controls state of |
| | | user defined filters to be |
| | | used in SceneController. |
| | | SceneController.cs: |
| | | Decides what data to hide/ |
| | | display based on filters. |
| Sub-process | User selects various | Initializer.cs: See above |
| Viewing | views that are defined | ImputController.cs: Listens |
| | in the data as sub- | for user inputs and selection |
| | processes of Static | of static objects. If static |
| | Objects. | object has a “view” defined and |
| | | a subset of static objects with |
| | | that same view exists, then |
| | | this “sub-process” will be |
| | | displayed instead of the |
| | | “main” view. |
| | | StaticObjectFactory.cs: |
| | | Factory pattern that |
| | | generatesvisual |
| | | representations of static |
| | | objects. |
| | | TransportLaneFactory.cs: |
| | | Factory pattern that |
| | | generates connectors/ |
| | | transport lanes between |
| | | static objects. |
| | | SceneController.cs: |
| | | Decides what static objects |
| | | to display based on sub- |
| | | process selection. |
| Mapping | User can select between | Initializer.cs: Initalizes |
| Type | automated conic mapping | the application, loads |
| | and user-defined | files, creates |
| | mapping. | connections between main |
| | | classes. |
| | | InputController.cs: Allows |
| | | user to |
| | | select the mapping type. |
| | | StaticObjectFactory.cs: |
| | | Based on the mapping type |
| | | will place the static object |
| | | in various layers. |
| | | DynamicObjectFactory.cs: |
| | | Generates visual |
| | | representation of dynamic |
| | | objects, in this case it |
| | | regenerates the endpoint |
| | | for movement based on |
| | | mapping type selection. |
| | | TransportLaneFactory.cs: |
| | | Ties into static object |
| | | factory to generate visual |
| | | connectors. |
| | | Upon user input the |
| | | placement of static objects |
| | | will change from that which |
| | | was defined by scene |
| | | settings and database data to |
| | | a calculated conic mapping. |
| | | Conic mapping can also |
| | | have user settings applied |
| | | (radius per type/each of |
| | | static object, height per type/ |
| | | each of static object). |
| Picture In | User can place a | Initializer.c: See above |
| Picture | secondary camera at any | InputController.cs: Sends |
| | location in the scene that | user input events to |
| | will display in a picture- | PictureInPictureController to |
| | in-picture window. | determine placement and |
| | | activation/deactivation of |
| | | secondary camera. |
| | | Secondary camera remains |
| | | stationary while main camera |
| | | is still free to move around |
| | | the scene. |
| | | PipCamera.cs: Controls the |
| | | display and placement of |
| | | picture-in-picture view. |
| Display of | User can display data | Initializer.cs: See above |
| Data Tables | (contents) associated | InputController.cs: |
| | with any static or | Handles user input to |
| | dynamic object in the | display tables. |
| | scene. This can be data | UiTableChartController.cs: |
| | queried from a database | Displays tables |
| | or retrieved from an | UiBarChartController.cs: |
| | Internet of Things device | Displays bar charts |
| | stream. | Upon user input, a static or |
| | | dynamic object will display |
| | | a chart or table of data that |
| | | is made of the “contents” of |
| | | a static/dynamic object. Said |
| | | data is often a set of |
| | | information such as status |
| | | of a shipment, inventory of |
| | | a warehouse, etc. This data |
| | | can be retrieved |
| | | dynamically from a |
| | | database or an Internet of |
| | | Things device data stream. |
| Display of | User can display video | Interior ViewController.cs: |
| Video Feeds | feeds as defined in scene | The user may select a |
| | settings or database | static/dynamic object with |
| | queries. Said feeds can | an associated video feed |
| | come from files or | and view it. Videos can be |
| | streaming video and can | 360-degree format which |
| | be 360-degree video or | simulates the user viewing |
| | regular 2D video. | the feed in 3D (such a |
| | | interior view of warehouse, |
| | | feed from drone with |
| | | cameras, etc). Videos can |
| | | also be standard 2D formats |
| | | for viewing within |
| | | a window in the application. |

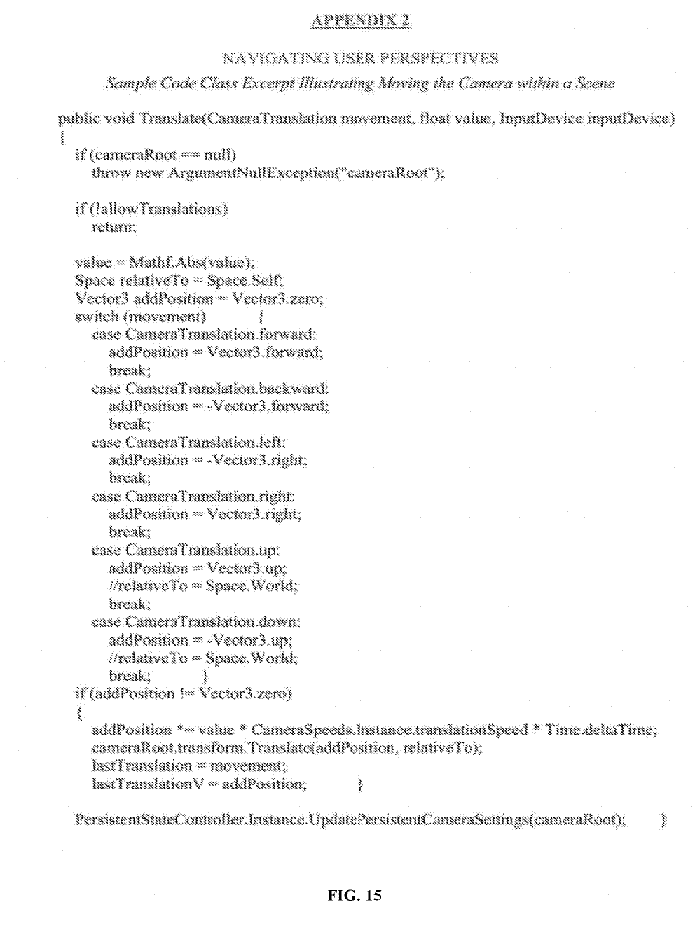

FIG. 15/Appendix 2 provides a sample code class excerpt which illustrates moving the camera within a scene.

Enterprise Work Activity Collaboration in a Virtual Space: The concept of collaboration in a virtual space is that two or more users run the same instance of a VUZOP scene. Vuzop provides such collaboration in the full context of visualized enterprise work activity integrated with camera video feeds and Internet of Things data feed. This enables users and organizations to occupy and share a virtual studio or command center for observing or managing the organization's work activities.

One user is designated the master user and the other collaborating user(s) act as a slave. The master user sends the current time and all user input to the collaborating user(s), which then apply that information to their local instance of the scene. In that way, collaborating users view the scene exactly as the master. Additionally, an avatar is shown for each user at their location in the scene pace. Users may create markers to indicate static or dynamic objects that they wish to collaborate on.

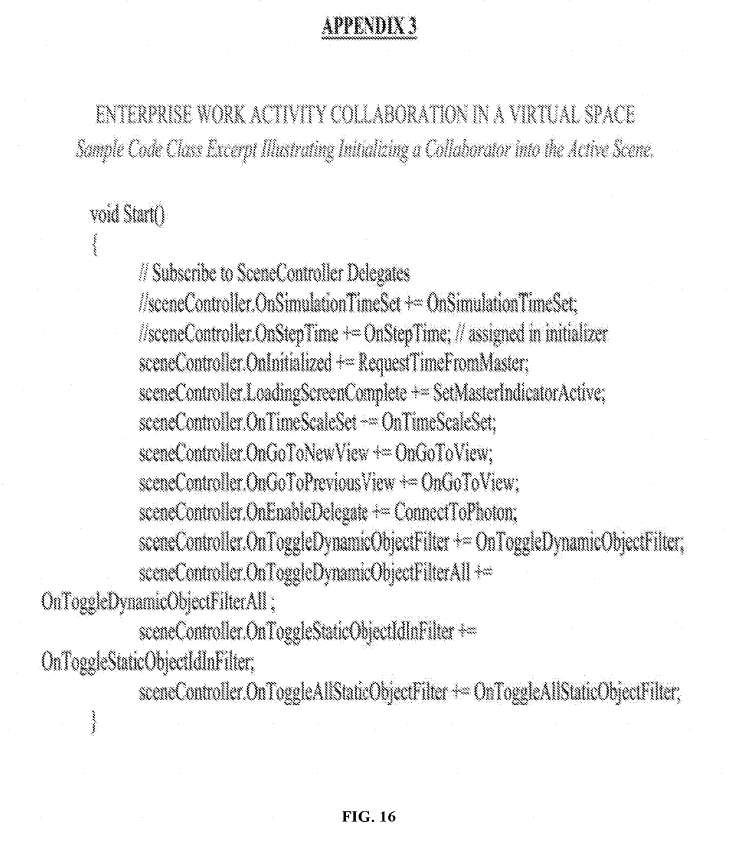

FIGS. 2A and 2B illustrate the steps (1-11) summarized below, to implement the creation and display of scenes. In each step, related code classes (FIGS. 11-13) are referenced as appropriate to reproduce the exemplary VUZOP embodiment.
1. Network Connection: Master user begins session in an instance of a scene. Collaborating user(s) connect to master user as slave client(s).
   a. SceneControllerPUN.cs: Contains remote procedure calls to sync states between master and collaborating users.
2. Master User Input: Master user's inputs sent to collaborating user(s).
3. Master User's Processes Synchronized with Collaborating User(s): Time values are sent to collaborating user(s). Filter values for static/dynamic object display are sent to collaborating user(s). Sub-process view selection is sent to collaborating user(s). Mapping type selection is sent to collaborating user(s). Picture in picture activation and camera placement is sent to collaborating user(s). Display of video feeds selection is sent to collaborating user(s).
   a. SceneControllerPUN.cs: Contains remote procedure calls to sync states between master and collaborating user.
4. Collaborating user( ) View of Scene Instances Updated Based on Inputs from Master User.
5. Master User's Avatar is Positioned on Collaborating User's Instance(s): User input is used to position a 3D avatar in the collaborating user(s) instances' scenes.
a. PhotonAvatar.cs: Responsible for synchronizing avatar positions based on each user's camera position. This class also controls voice communication.
6. Optional: Master User controls Collaborating User(s) Camera Positions: The Master User has the optional ability to control the position of all collaborating user(s) cameras. In this case, collaborating user(s) no longer have control over their camera positions.
   a. SceneControllerPUN.cs
7. Collaborating User(s) Input Process: Placement of indicator marks (arrows pointing to objects) are sent to master user
8. Master User Receives Collaborating User(s) Camera Position(s): If master user is not controlling the collaborating user(s) camera(s), then the user input from all collaborating user(s) in regards to camera positioning is sent to the master user. This is used to position the collaborating user(s) avatar(s) in the master user's scene as well as any other collaborating user(s) scene(s).
9. Place indicator marks: Users (master and collaborating) place arrows in the scene to indicate objects of interest. Position of said marks are synced between users.
   a. InputController.cs: Listens for inputs from user, sends events to camera controller.
10. Voice communication: Voice communication may be sent between all user-connected.
   a. PhotonAvatar.cs:
11. After Pre-Determined Time, Update Master User Scene Displayed; Return to Step 2
   Appendix 3 presented in FIG. 16 provides sample code class-excerpts which illustrate initializing a collaborator into the active scene.

### DETAILED DESCRIPTION OF ILLUSTRATIVE EMBODIMENTS

FIGS. 3-13 illustrate one embodiment of the invention as “VUZOP.”™

VUZOP is a system that provides visualization of business workflows and activities, integrates video and IoT data, and allows for collaboration in a VR 3D space, which may also be rendered in a 2D space. VUZOP creates animations of workflow activities and other business events by mining an organization's databases and integrating that business data with real world data from video cameras and IoT sensors.

An exemplary implementation (one embodiment) is for a large national retailer with four large warehouses, in Sacramento, Dallas, Chicago, and Newark, and one hundred stores in four regions across the country (Northeast, Southeast, Northwest and Southwest). FIG. 3 illustrates a VUZOP animation of the retailer's warehouses, stores and delivery routes. Users navigate their perspective and viewpoint in the virtual space, including time.

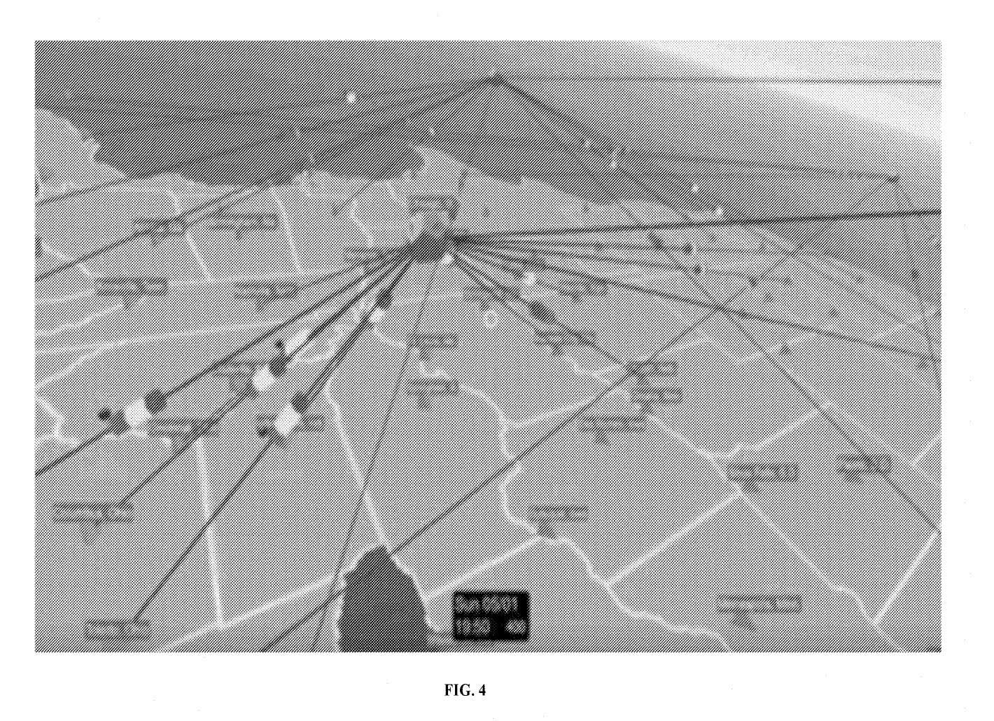

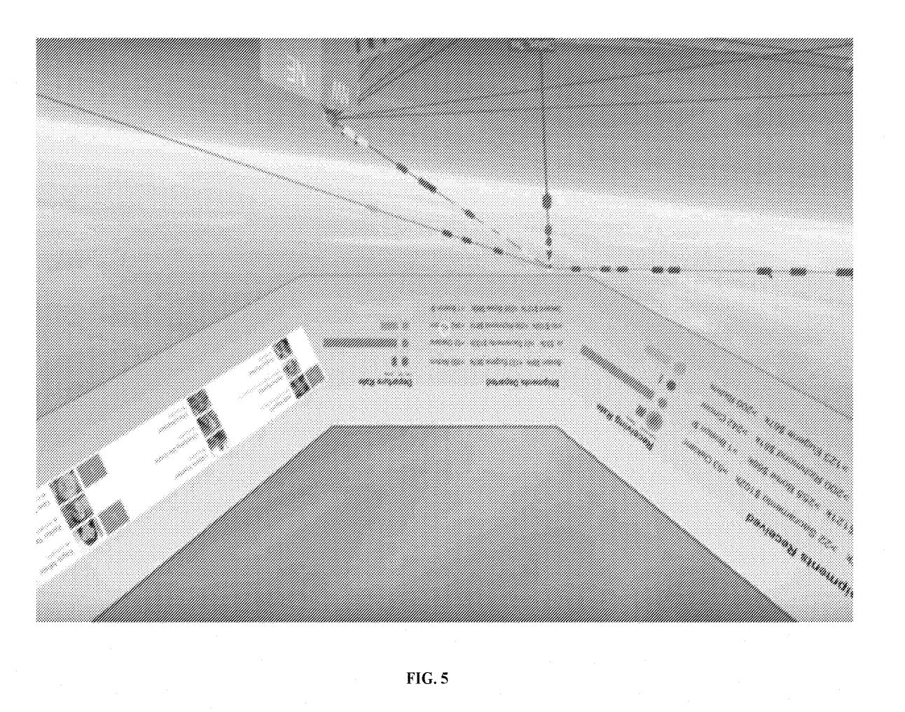

For example, in FIG. 4, a user has navigated and zoomed to more closely inspect operations to and from the Chicago warehouse. Users also incorporate animations of corporate systems' data in the virtual space. FIG. 5 shows a Vuzop VR user interface control panels that contain data from the corporate systems for running receiving and shipment integrated into the VR space.

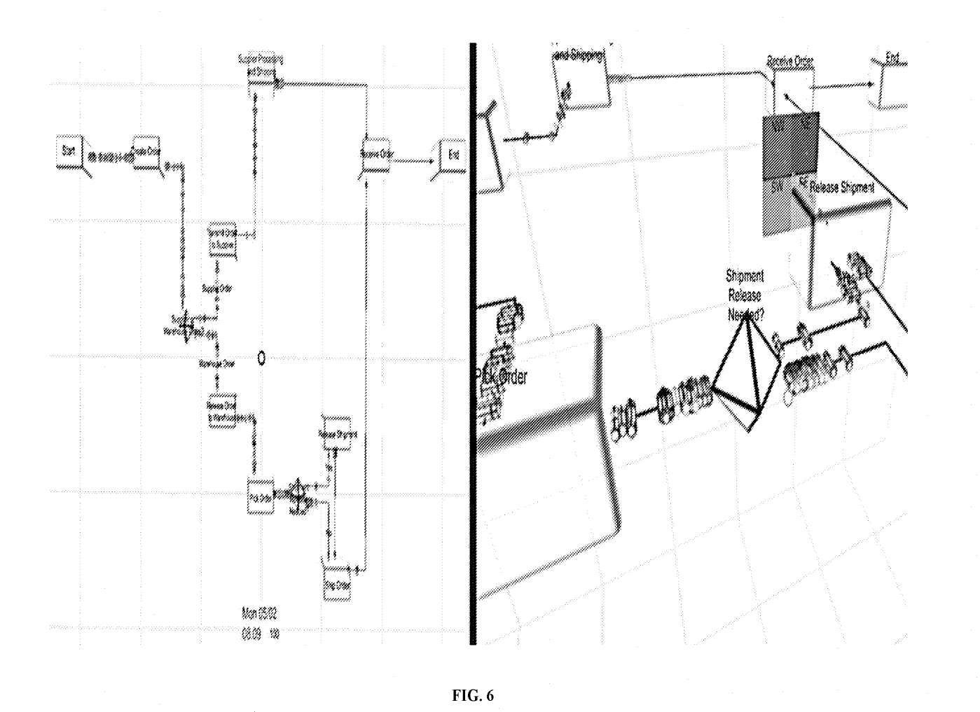

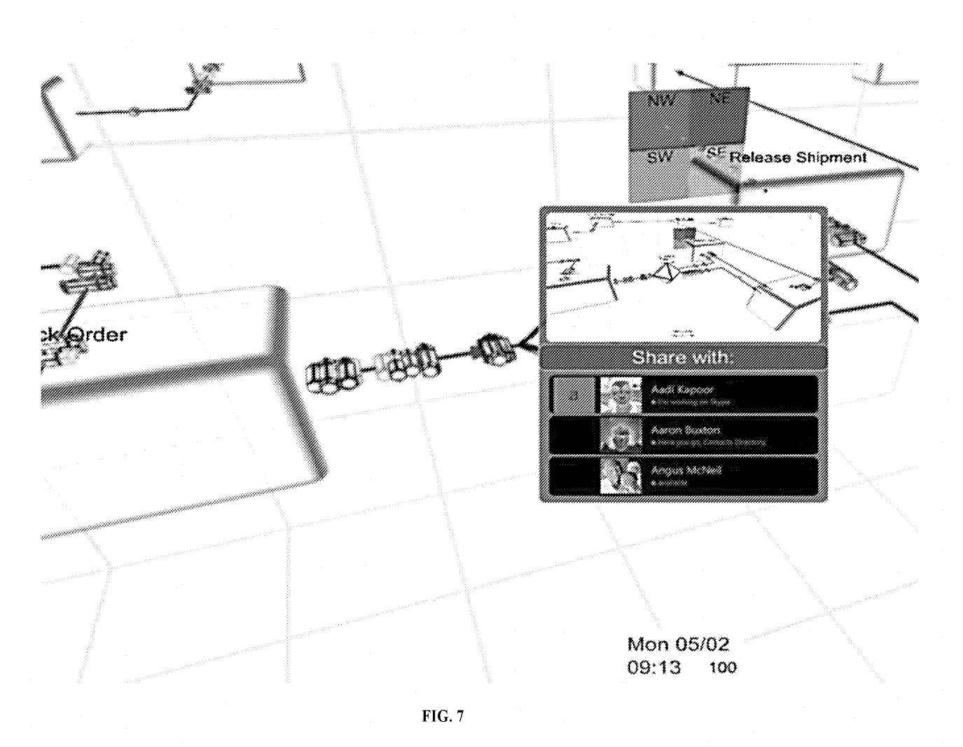

FIG. 6 illustrates workflow animations of the retailer's supply chain in a 3D VR space. Users can inhabit, and collaborate within, the same virtual space. For example, in FIG. 7, multiple users view an animation of the ordering and fulfillment processes, pinpoint an issue, and work together to resolve. it. As shown in FIG. 8, VUZOP also superimposes animations of workflow activities and other business data onto images from a live-streaming video camera, in 2D and 3D format. FIG. 8 illustrates animation of actual shipments leaving the Dallas warehouse superimposed on to that warehouse's live stream video. FIG. 8 also illustrates real-time or historical data superimposed on a delivery truck's live video feed.

Finally, VUZOP provides an interface so that businesses can create animations without programming, other than making simple modifications to SQL statements and XML settings.

FIG. 9 illustrates the components of the above exemplar VUZOP implementation. The VUZOP server is a computer, whether a standalone desktop PC or a cloud-based server, that interfaces with and accesses, an organization's databases, other Internet-based systems, servers and data, as well as Internet-enabled devices, such as video cameras and IoT sensors. The VUZOP server accesses the organization's business systems and their respective databases and other sources of data. Those business systems may be centrally located or distributed in regional office warehouses, stores and/or delivery vehicles. The internet-enabled video cameras and IoT sensors, located in warehouses vehicles and retail stores, stream data to VUZOP. Users in the corporate office, regional offices, including in stores and warehouses then define and modify VR spaces that contain animated workflows and other business activities. The users can also collaborate in those VR spaces.

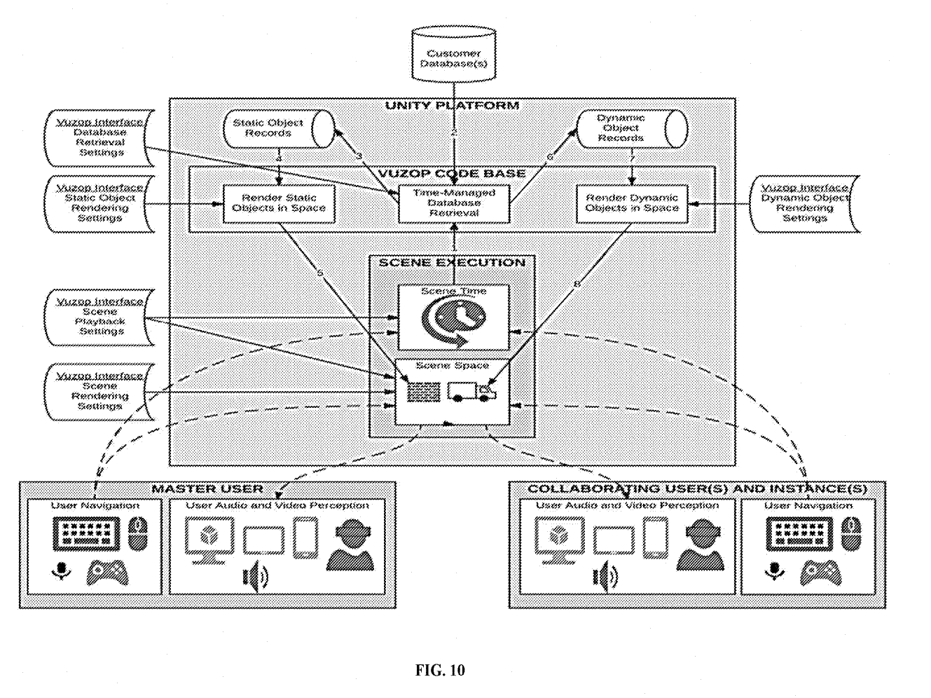

FIG. 10 illustrates the VUZOP framework which was developed using the Unity3D™ platform and a C# code base. Sample parameters settings, and sample code classes and excerpts for the exemplar Vuzop embodiment shown herein are further described in FIGS. 9-18 and Appendices 1-4, discussed infra and supra. VUZOP's central, organizing concept is scene execution. The VUZOP interface, user interactions and code base together execute said “scenes.”

Scene Execution is a function of Scene Space and Scene Time. Scenes are the virtual spaces described above, the 2D or 3D VR animation of workflow activities and other business events that integrate business data with real world data from video cameras and IoT sensors. VUZOP scenes are generally composed of the following elements: visual backgrounds; static, dynamic and transient objects; dynamic, curved and static connectors, and nested sub-processes.

Visual backgrounds can be a map (FIGS. 3-4), solid color (FIG. 5) or surrounding 3D image such a photograph or video feed, which may be rendered upon the inner side of a cube or sphere (FIGS. 3-7).

Static objects are visual elements in a scene that will not be moving, for example, the stores and warehouses in FIGS. 3 and 4. VUZOP provides numerous parameters that control a visual element's 3D position, color, size and shape. Parameters control when statics objects are visible in a scene based on time attributes, e.g., only show a Chicago warehouse from 6 am-midnight Central Time. Additionally, each static object can offer links to data feeds from video cameras and IoT sensors associated with them.

In FIG. 8, e.g., Warehouse A's video camera data and temperature sensor data are available from an Internet-accessible device identified by its uniform resource locators (“URL”). In addition to the ‘base’ attributes of a static object, static object attributes can periodically change at specific points in time. For example, at 3:00 pm, the color of a store is changed to blue and its size is doubled to alert the user to change in the store's status in some way.

Dynamic objects are visual elements that will be moving in the scene, such as electronic or physical orders or shipments going from warehouses to stores. FIG. 4, for example, shows shipments as dynamic objects in the shape of cylinders traveling from the Chicago warehouse to a store in Columbus, Ohio. VUZOP provides numerous parameters to control dynamic objects, such as the static objects that will be moved between (the ‘from’ and the ‘to’ objects) as well as the beginning and end times, or duration of when the dynamic objects move. Finally, as with static objects, dynamic object parameters include color, size, shape and associated URL.

VUZOP also provides filters that allow users to further manipulate how static and dynamic objects are displayed in scene. Static object filters allow the user to limit the display of workflow or events to only those that pertain to the static objects the user selected. For example, a user may choose to view only workflow that involve the Dallas warehouse. Dynamic object filters work in a similar way. Users may limit the limit the types of dynamic objects shown by using filters. For example, a user may choose to view only delivery trucks leaving the Dallas warehouse.

Transient objects are essentially static objects that change shape, size and color for a relatively short period of time (for example, a fraction of a second) to indicate or mark a momentary event (such a as sale at a store's cash register).

Connectors generally are visual representations of the paths between static objects upon which the dynamic object travel.

In FIG. 6, for example, a connector in the supply chain workflow animation exists between the static object ‘Transmit Order to Supplier’ and ‘Supplier Processing and Shipping’, both of which are specific workflow activities in the organization work processes. The dynamic object, ‘order’, travels between the two workflow activities.

There are two main types of connectors, dynamic and curved, as well as static connectors. Dynamic connectors are drawn at the time a dynamic object begins its travel between two static objects. In this exemplary implementation these connectors are drawn as straight lines. By default, the connector is removed when the travel is complete, though a scene setting allows the path to remain visible indefinitely. Curved connectors are a special type of dynamic connector that define a curved path between static objects, the purpose being to allow multiple, visually discernible paths between a pair of static objects. These connectors can be spatially distributed through either a 2D or 3D virtual space.

Static connectors are static objects used to pre-draw persistent paths between static objects. Static connectors are typically used in scenes where the visualization represents a workflow diagram, such as is used in business process management (“BPM”). The connector in FIG. 6 between ‘Transmit Order to Supplier’ and ‘ Supplier Processing and Shipping’ is an example of a static connector.

Nested sub-processes are typically found in workflow or BPM-type diagrams where one or more static objects in the currently-presented scene contains a deeper level of nested static or dynamic objects. By clicking on such a static object, a user can leave the current level and descend into a newly-presented scene that views the objects and workflow at the nested level. For example, a top-level BPM diagram may contain a static object representing the ‘Ship Order activity. If a user clicks on this object, the view changes to show several sub-activities within the Ship Order activity, such as ‘Prepare Labels’ and ‘Load Pallet’. The user sees all static and dynamic objects on this sub-level, and the corresponding animated workflow.

Further, VUZOP implements a web-style breadcrumb trail. This allows a user to drill down into scenes presenting increasingly lower levels of processes and sub-processes and to understand how these processes are operating. The user can also easily retrace the steps back up thru the traversed levels.

FIG. 10 illustrates ‘Scene Time,’ an important component of ‘Scene Execution.’ Even if animated visualizations are too complex for the user to grasp, they can still be relied on to point to crucial times/events of interest. Once potential areas of interest are identified, VUZOP enables users to easily manipulate time to examine what happened in the past, or what is happening in real time. VUZOP provides numerous ways a user may manipulate the time of the presented scene. As discussed, VUZOP presents scenes that animate workflow in real time or as “historical playbacks.”

VUZOP parameters allow the user to pause and resume the scene clock for playback; skip forward or backward by minutes, hour or days, reverse the direction of the clock so time runs backwards, loop the clock between a beginning and ending time, speed up or slow down the clock, including by very large factors such that a month of activity may be viewed in a minute, and synchronize clocks between multiple, concurrent scenes, among other manipulations.

VUZOP scenes are defined and manipulated by parameter values set by users. User settings are stored within VUZOP XML files. Parameter values for objects, connectors and nested sub-processes, discussed above, are stored in the VUZOP)(MIL files. Users customize SQL statements in the XML files to define the data that is to be retrieved for the desired animation from the organization's databases. Other settings in the)(MIL files specify URL access to the organization's video feeds and IoT devices. Parameters stored in the VUZOP XML files include, e.g., the following:
1. Specifications to relate latitude and longitude to the background map, if used;
2. Directory paths, or URLs, to video or other data feeds;
3. Saved camera positions that can be easily cycled through to change the view of the scene;
4. Speed at which those camera position transitions occur for stored camera positions;
5. Speed at which the camera is moved if moved manually by the user
6. Increment to use when changing the time scale being used for playback
7. Initial time scale used when scenes start.
8. Control for visibility size and background of text label in a scene;
9. Settings for curved connectors if used such as angle of curvature and persistence; and
10. Anchoring position to use for static objects that grow.

VUZOP Users create, modify and navigate scenes using the parameters and filters described above through a wide variety of computers, digital devices and virtual reality apparatuses as shown. Users can run multiple, independent scenes simultaneously, each being an “instance.” Two instances can be viewed side-by-side completely independent of each other, or synchronized together, with one instance acting as the master instance.

Master users invite other collaborating users to join them in an instance of a scene. The master and collaborating users can view the same instance of a scene, e.g. the same workflow and time scale as the master user. Master and collaborating users are essentially occupying the same virtual space. Users are represented in the VR scene by avatars. Avatars depict both the positions and perspectives of other users who have joined the scene for collaboration. Users can communicate with a virtual pointer, such as an illuminated line and virtual reference points, such as a persistent arrow to highlight points of interest in the work activity shown in the scene.

Scene execution, interfaces and user interactions are all made possible by the VUZOP C# code base running on a Unity3D™ platform. The VUZOP code base renders state and objects in the scene space based on the requested timeframe. The code base retrieves time-managed data from the necessary organization databases using the SQL statements in the VUZOP XML files. It applies the parameter settings and presents the desired static and dynamic objects in the Scene Space in the desired Scene Time.

FIGS. 11 through 13 illustrate the structure of VUZOP's code base. The code is structured in four layers: business, data access, application and presentation. As shown in FIG. 11, the Business Layer contains the structure and content of static and dynamic objects. This Layer contains the following classes:
Object Base: root of all object instantiation
Static Object: Object Base: attributes for static objects such as color, icon, etc.
Dynamic Object: Object Base: attributes for dynamic objects, such as from and to locations and arrival and departure times
Content Base: root of user data for all objects
Static Content: Content Base: user data for static objects, such as description values etc.
Dynamic Content: Content Base: user data for dynamic objects, such as values, etc.
Destination: holds data about the travel path location and timing for dynamic objects

The Data Access Layer (FIG. 11) provides the Application Layer access to the defined objects and database settings. This layer contains the following classes:
DBControllerAbstract: code for managing access of static and dynamic object data from user's relational database
SQLiteController: DBController: specific case of DBControllerAbstract for the SQLite database as used in development of embodiments of the invention
WWWDBController: DBController: code for managing access of static and dynamic object data from user's database through APIs
SettingsBase: code for managing the loading and saving of the XML settings files

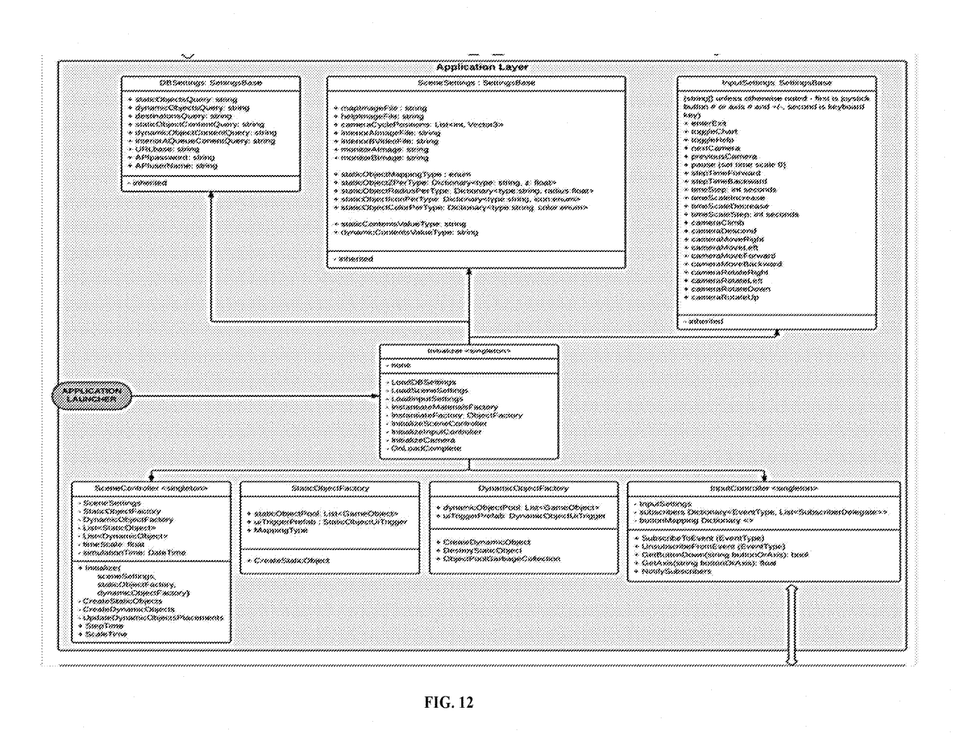

The Application Layer in FIG. 12 contains scene settings and, upon application launch, scene control including static and dynamic objects and input control. This layer contains the following classes:
DBSettings:Setting Base: SQLcommands for accessing the static, dynamic and transient data from the user's database
SceneSettings: SettingsBase: A set of values describing a variety of attributes about to be in scene, e.g. color of object, type, camera position, clock speed, etc.
InputSettings: Setting Base: A set of values that translate user input device signals to internal commands, e.g., a keyboard ‘x’ advances the time by one minute; keyboard mouse and game pad settings can all be specified;
Initializer: Controlling code for launching a Vuzop instance when a user starts the software
SceneController: Core code for managing the clock and the instantiation, movement and termination of object—attempt to re-compute the scene at least 30 times per second
StaticObjectFactory: Code for instantiating static objects
DynamicObjectFactory: Code for instantiating dynamic objects
InputController: Translates input settings to actions and executes them

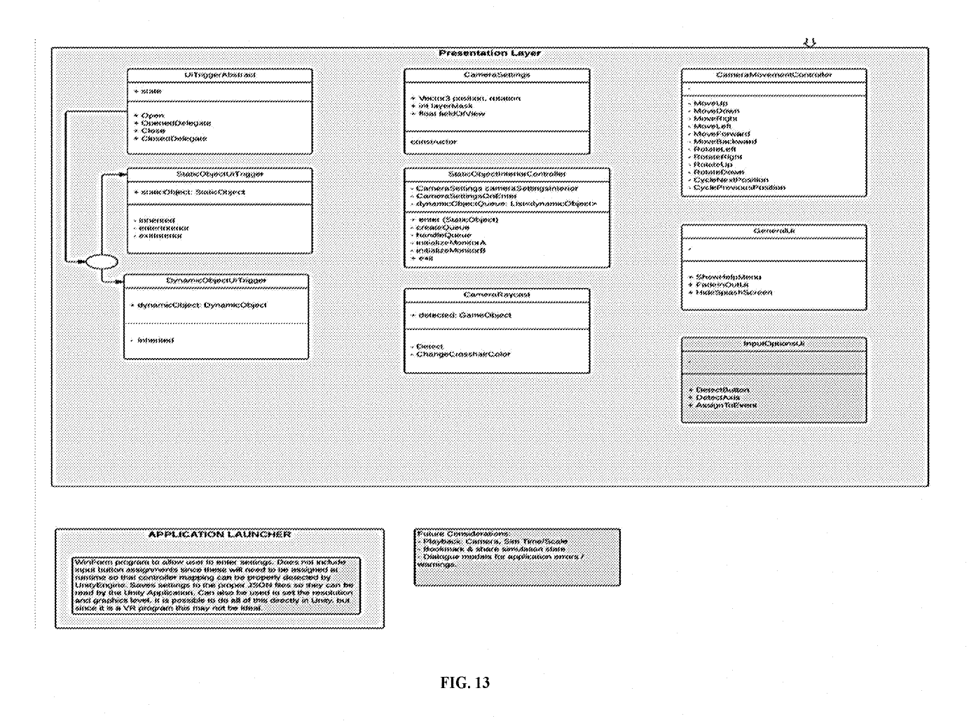

Finally, FIG. 13 illustrates the Presentation Layer, which contains the user interface. This layer contains the following classes:
UITriggerAbstract: Abstract class for defining user interaction via Unity trigger components.
StaticObjectUITrigger: Concrete implementation for handling clicks on static objects.
DynamicObjectUITrigger: Concrete implementation for handling clicks on dynamic objects.
StaticObjectInteriorController: Controls the display of interior views of static objects—i.e. 360-degree camera render plus visual representation of dynamic objects queued to exit from the static object selected.

### Further Alternate Embodiments

Another way to describe-and-embody the invention is to outline it as a computer-implemented Virtual Reality visualization tool which utilizes, integrates, illustrates and controls static and dynamic objects in real-time, wherein microprocessor embedded software, mobile devices, IoT camera video, and IoT sensor data together synthesize a real-time VR Business Operations Scene of at least one business with at least one business activity, said Scene comprising animation of the business's workflow, events, activities, facilities, assets and processes optional integrated camera video feeds from the business's facilities optional integrated Internet of Things sensor data feed from the business;
wherein said Scene may be captured, stored and illustrated as a historical Scene memorialized in time, and then simultaneously compared with said real-time Scene.
The process may further comprising a user who controls the time of said Scene via pause and restart playback speed up or slow down playback, reverse playback loop playback repeatedly skip periods of inactivity in the playback, such as for holidays.
The tool may also feature the user navigating the VR space of the business Operations Scene by moving through three dimensions of the VR space, accompanied with three dimensions of rotation of the camera viewport, such navigation being facilitated by one or more of a keyboard, mouse, gamepad controller, VR headset, hand-tracking or foottracking data, wherein objects depicted in the Scene are designed to take the user to another Scene upon entering an object as a portal, allowing user to jump into any area of the business' activities and then immediately dive into nested sub-activities; the user marks significant viewpoint locations in the Scene are be marked by the user to later tour these locations from convenient viewing locations; objects in [the VR Space] Scene have associated corresponding camera feeds, so the user executes a logical “click” on the object to view its associated camera feed and if the camera is a 2D camera then a flat panel is displayed showing the camera feed or recording, but if the camera is a 3D camera then the feed or recording is mapped to the inside of a sphere or cube and the user experiences the act of “entering” the object and being repositioned inside of it, then once inside said object the user rotates the camera view to see a 360 degree 3D view of resulting camera images, and wherein all such views are maintained and available in real time or in historical time, so inside each “object” the user may superimpose additional Scene images on the camera feed, additional data screens appear in chosen positions to provide detailed data and statistics qualifying the objects being viewed in the Scene; a Halo menu of data, feeds and controls appears “above” the user's view in the Scene, enabling the user to simply look upward at any time to see additional views, streaming IoT device data feeds, and wherein one or more collaborators, and optional images of these collaborators, simultaneously use the same tools to navigate the same Scene.
The tool may also feature users collaborating in the same Scene, wherein one or more users may view the same Scene, said users seeing the same VR “world” being executed and portrayed and all see the same facilities, assets, workflow, activities, camera feeds, IoT feeds, and wherein said Scene is dependent on where the user looks, but each user may view said Scene from a different location and gaze in a different direction; and each user is free to navigate the shared VR Scene as they are normally allowed to navigate only the “master user” is allowed to control the time features each user is depicted in the Scene with an avatar so each user sees the others' position and direction of gaze; each user may point to objects or locations in the VR Operations Scene with a simulated “laser” device so that other users can clearly see what the user is directing their attention towards when a user points at an object or location in the Scene the user has the option of attaching a “sticky marker” to that object or location for future visual reference; users may optionally also communicate verbally through the VR device they are using.
A user may also create two or more instances of Vuzop executing simultaneously on the computer being used to execute it so the two instances may appear in separate windows and the user may position them side by side or in any desired arrangement, so if the instances are of the same Scene then the user may choose to synchronize said Scenes, thereby collaborating with oneself, wherein the other instances may add an offset to the time so one instance may show one Scene time while another instance shows another Scene executing at the specified time offset.
The user may also create VR Business Operations Scenes through simple configurations rather than computer programming, by filling out parameters in an XML file in which the user specifies the visual attributes of the objects that will appear in the Scene, said files being comprised of static objects: by completing a template of SQL statements the user imports the business data from the business database to populate the facilities, assets and processes that will be depicted in the scene; transient objects: by completing another template of SQL statements the user imports the business data from the business database to drive visual changes over time of the facilities, assets, processes and other beneficial objects that will be depicted in the scene; dynamic objects: by completing other SQL templates the user imports the business data that will be used to drive the animation of workflow, events and activities that will execute in the scene; camera feeds: by providing the URL's of live cameras or their historical archives the user imports the images into the scene. By associating those URLs with other objects in the scene the user links the camera images to business facilities, assets and other processes in the scene; and IoT sensor data feeds: by providing the URL's of IoT sensor devices or their historical archives the user imports the sensor data into the scene. By associating those URLs with other objects in the scene the user links the sensor data to business facilities, assets and other processes in the scene. If sensor data is to be accessed through business databases then template SQL statements can be completed instead of URL's.

In the Summary and Descriptions above and the Claims and Descriptions below, and in the accompanying drawings, reference is made to particular features of various embodiments of the invention.

It is to be understood that the disclosure of embodiments of the invention in this specification includes all possible combinations of such particular features. For example, where a particular feature is disclosed in the context of a particular aspect or embodiment of the invention, or a particular claim, that feature can also be used—to the extent possible—in combination with and/or in the context of other particular aspects and embodiments of the invention, and in the invention generally.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

In the present disclosure, various features may be described as being optional, for example, through the use of the verb “may;”, or, through the use of any of the phrases: “in some embodiments,” “in some implementations,” “in some designs,” “in various embodiments,” “in various implementations,”, “in various designs,” “in an illustrative example,” or “for example;” or, through the use of parentheses. For the sake of brevity and legibility, the present disclosure does not explicitly recite each and every permutation that may be obtained by choosing from the set of optional features. However, the present disclosure is to be interpreted as explicitly disclosing all such permutations. For example, a system described as having three optional features may be embodied in seven different ways, namely with just one of the three possible features, with any two of the three possible features or with all three of the three possible features.

In various embodiments, elements described herein as coupled or connected may have an effectual relationship realizable by a direct connection or indirectly with one or more other intervening elements.

In the present disclosure, the term “any” may be understood as designating any number of the respective elements, i.e. as designating one, at least one, at least two, each or all of the respective elements. Similarly, the term “any” may be understood as designating any collection(s) of the respective elements, i.e. as designating one or more collections of the respective elements, a collection comprising one, at least one, at least two, each or all of the respective elements. The respective collections need not comprise the same number of elements.

While various embodiments of the present invention have been disclosed and described in detail herein, it will be apparent to those skilled in the art that various changes may be made to the configuration, operation and form of the invention without departing from the spirit and scope thereof. In particular, it is noted that the respective features of embodiments of the invention, even those disclosed solely in combination with other features of embodiments of the invention, may be combined in any configuration excepting those readily apparent to the person skilled in the art as nonsensical.

Likewise, use of the singular and plural is solely for the sake of illustration and is not to be interpreted as limiting.

In the present disclosure, all embodiments where “comprising” is used may have as alternatives “consisting essentially of,” or “consisting of.” In the present disclosure, any method or apparatus embodiment may be devoid of one or more process steps or components.

In the present disclosure, embodiments employing negative limitations are expressly disclosed and considered a part of this disclosure.

Certain terminology and derivations thereof may be used in the present disclosure for convenience in reference only and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

The term “comprises” and grammatical equivalents thereof are used herein to mean that other components, ingredients, steps, among others, are optionally present. For example, an embodiment “comprising” (or “which comprises”) components A, B and C can consist of (i.e., contain only) components A, B and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose limit is the second number. For example, 25 to 100 mm means a range whose lower limit is 25 mm and upper limit is 100 mm.

Many suitable methods and corresponding materials to make each of the individual parts of embodiment apparatus are known in the art.

According to an embodiment of the present invention, one or more of the parts may be formed by machining, 3D printing (also known as “additive” manufacturing), CNC machined parts (also known as “subtractive” manufacturing), and injection molding, as will be apparent to a person of ordinary skill in the art. Metals, wood, thermoplastic and thermosetting polymers, resins and elastomers as may be described herein-above may be used. Many suitable materials are known and available and can be selected and mixed depending on desired strength and flexibility, preferred manufacturing method and particular use, as will be apparent to a person of ordinary skill in the art.

Any element in a claim herein that does not explicitly state “means for” performing a specified function, or “step for” performing a specific function, is not to be interpreted as a “means” or “step” clause as specified in 35 U.S.C. § 112 (f). Specifically, any use of “step of” in the claims herein is not intended to invoke the provisions of 35 U.S.C. § 112 (f).

According to an embodiment of the present invention, the system and method may be accomplished through the use of one or more computing devices. As depicted, for example, in FIG. 1, one of ordinary skill in the art would appreciate that an exemplary system appropriate for use with embodiments in accordance with the present application may generally include one or more of a Central processing Unit (CPU), Random Access Memory (RAM), a storage medium (e.g., hard disk drive, solid state drive, flash memory, cloud storage), an operating system (OS), one or more application software, a display element, one or more communications means, or one or more input/output devices/means. Examples of computing devices usable with embodiments of the present invention include, but are not limited to, proprietary computing devices, personal computers, mobile computing devices, tablet PCs, mini-PCs, servers or any combination thereof. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In various embodiments, communications means, data store(s), processor(s), or memory may interact with other components on the computing device, in order to effect the provisioning and display of various functionalities associated with the system and method detailed herein. One of ordinary skill in the art would appreciate that there are numerous configurations that could be utilized with embodiments of the present invention, and embodiments of the present invention are contemplated for use with any appropriate configuration.

According to an embodiment of the present invention, the communications means of the system may be, for instance, any means for communicating data over one or more networks or to one or more peripheral devices attached to the system. Appropriate communications means may include, but are not limited to, circuitry and control systems for providing wireless connections, wired connections, cellular connections, data port connections, Bluetooth connections, or any combination thereof. One of ordinary skill in the art would appreciate that there are numerous communications means that may be utilized with embodiments of the present invention, and embodiments of the present invention are contemplated for use with any communications means.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description may set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a sequence of computational instructions or program instructions. It will be appreciated that a programmable apparatus (i.e., computing device) can receive such a computer program and, by processing the computational instructions thereof, produce a further technical effect.

A programmable apparatus may include one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components.

Accordingly, other implementations are contemplated within the scope of the following claims.

What is claimed is:

1. A computer-implemented Virtual Reality visualization process tool which utilizes, integrates, illustrates and controls static and dynamic objects in real time, wherein microprocessor embedded software, mobile devices, IoT camera video feeds, and IoT sensor data together synthesize a real-time VR Business Operations Scene of at least one business with at least one business activity, said Scene comprising:
animation of the business's workflow, events, activities, facilities, assets and processes;
optional integrated camera video feeds from the business's facilities;
optional integrated Internet of Things sensor data feed from the business;
wherein said Scene is captured, stored and illustrated as a historical Scene memorialized in time, and then simultaneously compared with said real-time Scene.

2. The process of claim 1, further comprising a user who controls the time of said Scene via
a. pause and restart playback,
b. speed up or slow down playback,
c. reverse playback,
d. loop playback repeatedly,
e. skip periods of inactivity in the playback, such as for holidays.

3. The tool of claim 1, further comprising a user (and optionally additional collaborator users) who sees and navigates the VR space of the Business Operations Scene (“Scene”) by moving through three dimensions of the VR space, accompanied with three dimensions of rotation of a camera viewport, such navigation being facilitated by one or more of a keyboard, mouse, gamepad controller, VR headset, hand-tracking or foottracking data, so that:
a. objects depicted in the Scene act as portals taking the user to another Scene, allowing user to jump into any area of the business' activities and then immediately dive into nested sub-activities;
b. significant viewpoint locations in the Scene are marked and later toured by the user;
c. objects in the Scene have associated corresponding camera feeds and recordings, so the user executes a logical “click” on the object to view its associated camera feed, and when the camera is a 2D camera then a flat panel is displayed showing the camera feed or recording, and when the camera is a 3D camera then the feed or recording is mapped to the inside of a sphere or cube and the user experiences the act of “entering” the object and being repositioned inside of it, then once inside said object the user rotates the camera view to see a 360 degree 3D view of resulting camera images, and wherein all such views are maintained and available in real time or in historical time, so inside each “object” the user may superimpose additional Scene images on the camera feed,
d. additional data screens appear in chosen positions to provide detailed data and statistics qualifying the objects being viewed in the Scene;
e. a Halo menu of data, feeds and controls appears in a position immediately above the user's view in the Scene, enabling the user to instantly look upward at any time to see additional views, streaming IoT device data feeds; and
f. wherein one or more collaborators, and optional images of these collaborators, simultaneously use said tool to navigate the same Scene.

4. The tool of claim 1, further comprising a user and at least one additional collaborator-user, together navigating the same Scene, wherein
a. one or more users may view the same Scene, said users seeing the same VR “world” being executed and portrayed and all see the same facilities, assets, workflow, activities, camera feeds, IoT feeds, and wherein said Scene is dependent on “where” the user looks, but wherein each user still views said Scene from user's own gaze-orientation and from user's own location-position; and
b. wherein each user still navigates the shared VR Scene as though they were each navigating solo;
c. only the “master user” is allowed to control the time features;
d. each user is depicted in the Scene with user's own avatar, so each user sees the other user's position and direction-of-gaze;
e. wherein each user points to objects-and-locations in the VR Operations Scene with a simulated “laser” device-feature so the other user sees what the user is pinpointing;
f. when user points at an object/location in the Scene, user has the option of attaching a “sticky marker” to the object/location for future visual reference within the Scene; and wherein
g. users may optionally communicate verbally through the VR device they are using.

5. The process of claim 1, wherein a user may creates two or more instances of said Scene executing simultaneously so the two instances appear in separate windows, and wherein the user positions them side-by-side or randomly, so when the instances are of the same Scene the user synchronizes said Scenes, thereby collaborating with oneself, wherein other disparate instances may add an offset to the time feature, so that one instance shows one Scene-time while another instance shows another Scene-time, simultaneously executing at the specified time-offset.

6. The process of claim 1, further comprising a user who creates VR Business Operations Scenes with associated animations workflows events and activities, said creation built through simple configurations rather than computer programming, where said configurations are the setting-of parameters in at least one XML file in which the user specifies the visual attributes of the objects to appear in the Scene, said file being comprised of:
a. static objects: by completing at least one template of SQL statements, the user imports business data from a business database to populate the facilities, assets and processes depicted in the Scene;
b. transient objects: by completing another template of SQL statements, the user imports business data from a business database to drive visual changes over time of the facilities, assets and processes depicted in the scene;
c. dynamic objects: by completing at least one other SQL template, the user imports business data to drive the animation of workflow, events and activities that execute the Scene;
d. camera feeds: by providing the URLs of live cameras or of said cameras' historical archives, the user imports the images into the scene, and by associating these URLs with other objects in the Scene, the user links the camera images to business facilities, assets and other processes in the scene; and
e. IoT sensor data feeds: by providing the URLs of IoT sensor devices or their historical archives the user imports the sensor data into the scene, and then by associating these URLs with other objects in the scene the user links the sensor data to business facilities, assets and other processes in the scene, and when sensor data is accessed through business databases, template SQL statements are completed rather than URLs.
